(19) United States
(12) Patent Application Publication
(10) Pub. No.: US 2009/0053418 A1
(43) Pub. Date: Feb. 26, 2009

(54) Coating Method and Apparatus

(76) Inventors: Kazuhiko Nojo, Shizuoka (JP); Youichi Hasegawa, Shizuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 11/886,636

(22) PCT Filed: Mar. 15, 2006
(86) PCT No.: PCT/JP2006/305622

§ 371 Date: Sep. 18, 2007

(30) Foreign Application Priority Data
Mar. 18, 2005 (JP) 2005-080170

(51) Int. Cl. B05D 3/12; B05C 5/02

(52) U.S. Cl. 427/356; 118/322

(57) ABSTRACT

According to the coating method of the present invention, the uneven portion on the land of the upstream side makes it possible to increase a contact area between the coating solution and the land, thereby improving the stability of a bead. In other words, according to the coating method of the present invention, it is possible to improve the stability of a bead on the upstream side, the stability having been reduced by the overbite shape of the die. Thus, even when a coating solution having a low viscosity of 10 cp or less is applied with a small coating amount of 10 cc/m2 or less, it is possible to increase the speed of the web without causing an uneven coating.

### TECHNICAL FIELD

The present invention relates to a coating method and apparatus, and particularly to a coating method and apparatus for forming a coating of an optical film such as an antireflection coating using a die.

### BACKGROUND ART

In a coating method using a die, a coating solution is extruded from the slit of the die while a belt-like base (web) is moved in one direction. A coating solution bridge (bead) is formed between the die and the base, so that a coating film is evenly formed on the base. In this coating method, the stability of the bead considerably affects coating accuracy. As the running speed of the base increases, the bead is pulled by the base and thus may be broken on the position of a lower lip of the die. Thus, a suction chamber is generally provided under a bead and the stability of the bead is kept by pulling the bead downward (in the opposite direction from the running direction of the base).

Another method is disclosed in Patent Document 1 in which water-repellent resin is applied to a lip of a die. With this configuration, a bead can be stabilized and failures such as stripes, a tailed line, and a discontinuous liquid flow can be prevented in Patent Document 1. However, Patent Document 1 has problems in the high-precision processing of the lip and the strength of the resin.

Patent Document 2 proposes a method in which a simple resin coating is replaced with a composite plating coating obtained by the dispersion and eutectoid of a fluorine-containing resin, so that the accuracy of a lip is kept and a hard coating is formed while the repellency of pure Teflon is maintained.

Patent Document 3 proposes a method of applying a hard ceramic to prevent a solid matter included in a coating solution from abrading a surface of a lip of a pressing die. Patent Document 4 proposes a method in which hollows are formed on the edges of upper and lower lips and the meniscus of a bead is made uniform in the width direction to achieve stabilization.

Patent Document 5 proposes a method in which a downstream-side lip is protruded more than an upstream-side lip to a base in the running direction of the base so as to form an overbite shape. According to this method, a thin film coating is obtained by minimizing a clearance between the base and the downstream-side lip of a die.

[Patent Document 1] Japanese Examined Application Publication No. 1-57629

[Patent Document 2] Japanese Patent Application Laid-Open No. 5-261330

[Patent Document 3] Japanese Patent Application Laid-Open No. 6-121953

[Patent Document 4] Japanese Patent Application Laid-Open No. 5-345161

[Patent Document 5] Japanese Patent Application Laid-Open No. 2003-211052

### DISCLOSURE OF THE INVENTION

In the inventions of Patent Documents 1 to 5 described above, however, when a coating amount is small and a coating solution has a low viscosity (particularly when a coating amount is 10 cc/m2 or less and a viscosity is 10 cp or less), the faster the base moves, the bead becomes unstable, a thickness becomes uneven in the width direction, and an uneven striped coating appears on a coating surface. Hence, in Patent Documents 1 to 5, when a small disturbance affects a bead or wettability between the coating solution and the base slightly changes, the bead is broken.

Further, Patent Document 5 requires high installation accuracy for the die as well as extremely high manufacturing accuracy. For example, a clearance between a lip end and the base has to be several tens μm. For this reason, the cost of facilities increases and a long time is required for preparation before coating, resulting in lower productivity.

The present invention is designed in view of these circumstances and has as its object the provision of a coating method and apparatus which can increase a coating speed when a coating solution with a viscosity of 10 cp or less is applied with a wet coating amount of 10 cc/m2 or less.

In order to attain the object, a first aspect of the present invention provides a coating method, in which coating is performed with a wet coating amount of 10 cc/m2 or less by discharging a coating solution with a viscosity of 10 cp or less from an extrusion opening of a die to a continuously running web supported by a backup roller, characterized in that the coating is performed by means of the die in which a lip on the downstream side of the extrusion opening is protruded to the web more than a lip on the upstream side of the extrusion opening relative to the running direction of the web, and an uneven portion including a plurality of asperities is formed on a land on the end of the upstream-side lip.

According to the first aspect of the present invention, the uneven portion on the land of the upstream side makes it possible to increase a contact area between the coating solution and the land, thereby improving the stability of a bead. In other words, according to the first aspect of the present invention, it is possible to improve the stability of a bead on the upstream side, the stability having been reduced by the overbite shape of the die. Thus, even when a coating solution having a low viscosity of 10 cp or less is applied with a small coating amount of 10 cc/m2 or less, it is possible to increase the speed of the web without causing an uneven coating.

A second aspect of the present invention, according to the first aspect, is characterized in that the uneven portion is formed over the land of the upstream side. According to the second aspect, since the uneven portion is formed over the land, it is possible to remarkably increase a contact area between the coating solution and the land, achieving a more stable bead.

A third aspect of the present invention, according to the first aspect, is characterized in that the uneven portion is formed on both ends in the width direction of the land of the upstream side. According to the third aspect, the uneven portion is formed on both ends in the width direction where a bead becomes the most unstable, and thus the bead can be effectively stabilized. Further, according to the third aspect, the uneven portion is not provided at the center in the width direction and thus it is possible to minimize a change in the thickness of a central portion serving as a product. Therefore, according to the third aspect, it is possible to stabilize a bead and prevent the occurrence of stripes or the like while achieving an even thickness of a product.

A fourth aspect of the present invention, according to any one of the first to third aspects, is characterized in that the asperities of the uneven portion have a depth of 5 μm to 500 μm and a pitch of 50 μm to 500 μm. In the case of a depth less than 5 μm, the effect of the uneven portion is not sufficient and a bead becomes unstable. Conversely in the case of a depth exceeding 500 μm, the straightness of the lip decreases in the width direction and thus a thickness becomes uneven. In the case of a pitch less than 50 μm, the straightness of the lip decreases and a bead becomes unstable. Conversely in the case of a pitch exceeding 500 μm, the effect of the uneven portion is not sufficient and a bead becomes unstable. According to the fourth aspect, the depth and pitch of the asperities are set within the above ranges and thus it is possible to sufficiently stabilize a bead and form an even coating.

A fifth aspect of the present invention, according to any one of the first to fourth aspects, is characterized in that the uneven portion is formed by performing matting, ceramic spraying, or engraving on the land of the upstream side. The uneven portion described above can be formed by the method of the fifth aspect.

A sixth aspect of the present invention, according to any one of the first to fifth aspects, is characterized in that the coating solution is an organic solvent containing particles of 10 nm to 10 μm.

A seventh aspect of the present invention, according to the sixth aspect, is characterized in that the coating solution contains an acrylic UV curing resin or an epoxy thermosetting resin.

In order to attain the object, an eighth aspect of the present invention provides a coating apparatus including a backup roller for supporting a continuously running web, and a die having an extrusion opening for a coating solution, the die being disposed close to the web wrapped around the backup roller, the apparatus coating the web with the coating solution having a viscosity of 10 cp or less with a wet coating amount of 10 cc/m2 or less, characterized in that in the die, a lip on the downstream side of the extrusion opening is protruded to the web more than a lip on the upstream side of the extrusion opening relative to the running direction of the web, and an uneven portion including a plurality of asperities is formed on a land on the end of the upstream-side lip.

According an eighth aspect, the uneven portion on the land of the upstream side makes it possible to increase a contact area between the coating solution and the land, thereby improving the stability of a bead. In other words, according to the eighth aspect of the present invention, it is possible to improve the stability of a bead on the upstream side, the stability having been reduced by the overbite shape of the die. Thus, even when a coating solution having a low viscosity of 10 cp or less is applied with a small coating amount of 10 cc/m2 or less, it is possible to increase the speed of the web without causing an uneven coating.

According to the present invention, the uneven portion on the land of the upstream side makes it possible to stabilize a bead. Thus, even when a coating solution having a low viscosity of 10 cp or less is applied with a small coating amount of 10 cc/m2 or less, it is possible to increase the speed of the web and improve productivity.

### BRIEF DESCRIPTION OF THE DRAWINGS

FIG. 1 is a schematic diagram showing the configuration of a coating apparatus according to the present invention;

FIG. 2 is a side sectional view showing the end shape of a die;

FIG. 3 is a front view showing an upstream-side land of the die;

FIG. 4 is a front view showing the upstream-side land of a die having an uneven portion different from FIG. 3;

FIG. 5 is a front view showing the upstream-side land of a die having an uneven portion different from FIG. 3; and

FIG. 6 is a front view showing the upstream-side land of a die having an uneven portion different from FIG. 3.

### Description of the Symbols

10 coating apparatus
12 web
14 die
16 backup roller
18 pocket
20 slot
20A extrusion opening
22 suction chamber
23 upstream-side lip
24 upstream-side land
25 downstream-side lip
26 downstream-side land
30 uneven portion

### BEST MODE FOR CARRYING OUT THE INVENTION

The following will describe a preferable embodiment of a coating method and apparatus of the present invention in accordance with the accompanying drawings.

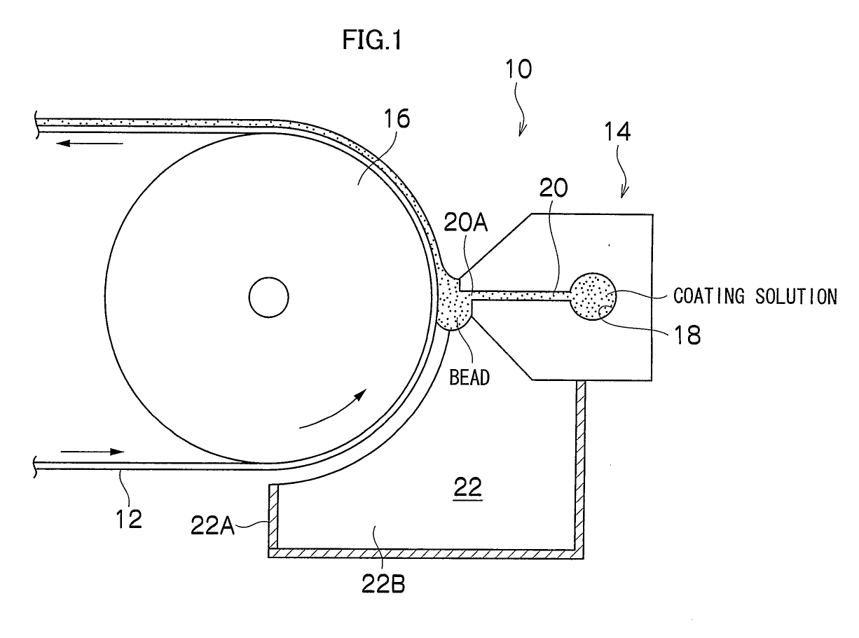

FIG. 1 is a schematic diagram showing the configuration of the coating apparatus to which the present invention is applied. As shown in FIG. 1, a coating apparatus 10 is mainly constituted of a die 14 and a backup roller 16. A continuously running web 12 is wrapped around and supported on the backup roller 16. The web 12 continuously runs in the direction of the arrow and the backup roller 16 rotates at the same speed as the web 12. The backup roller 16 has, for example, a diameter of 100 mm to 400 mm and a surface roughness of 0.8 S or less. Further, the backup roller 16 is made of, for example, a metal such as iron and coated with HCr plating.

The die 14 is disposed close to the web 12 which is wrapped around and supported on the backup roller 16. A pocket 18 and a slot 20 are formed in the die 14. The pocket 18 is the reservoir of a coating solution. The pocket 18 is formed in the width direction of the die 14 and is almost circular in cross section. The length of the pocket 18 in the width direction is equal to or slightly larger than a coating width. Further, the pocket 18 is connected to an inlet (not shown) provided for the coating solution on a side of the die 14 and the coating solution is fed from the inlet to the pocket 18. The cross-sectional shape of the pocket 18 is not limited to a circle and may be other shapes such as a trapezoid. The position of the inlet of the coating solution fed to the pocket 18 is not limited to a side of the die 14 and the inlet may be disposed at the center in the width direction of the die 14 on the opposite side from the backup roller 16.

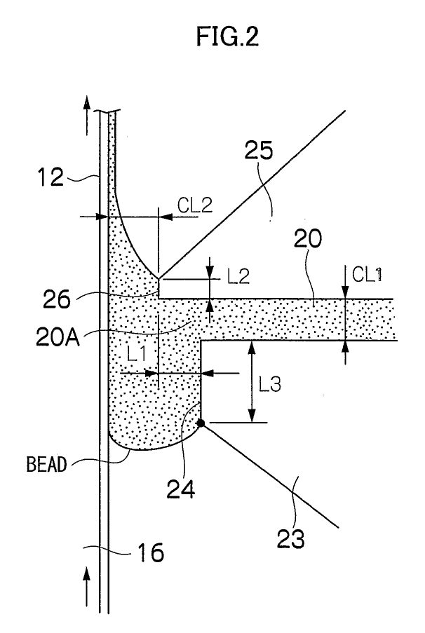

The slot 20 is the path of the coating solution from the pocket 18 to the web 12. The coating solution in the pocket 18 is extruded from an extrusion opening 20A, which is disposed on the end of the slot 20, to the web 12 through the slot 20. The slot 20 is formed like a slit in the width direction of the die 14. The length of the slot 20 in the width direction is set by a width regulation plate (not shown) at, for example, 100 mm to 2000 mm, which is almost equal to the coating width. A clearance CL1 (FIG. 2) of the slot 20 is, for example, 50 μm to 500 μm.

Under the die 14 configured thus (in other words, on the upstream side in the running direction of the web 12), a suction chamber 22 is provided. The suction chamber 22 has a back plate 22A raised under the backup roller 16 and side plates 22B raised in the width direction. The suction chamber 22 is surrounded by the back plate 22A, the side plates 22B, the die 14, and so on. The suction chamber 22 is connected to decompressing means (not shown) and can be adjusted to a predetermined degree of decompression. The back plate 22A is attached so as to be adjusted in height, and it is possible to adjust a gap between the upper end of the back plate 22A and the web 12 wrapped around the backup roller 16. The gap is set larger than a clearance CL2 between a downstream land 26 (described later) and the web 12. Thus, it is possible to reduce a change in the degree of compression around a bead, the change being caused by the eccentricity of the backup roller 16. The gap between the upper end of the back plate 22A and the web 12 is preferably set at 100 μm to 500 μm.

FIG. 2 is a side view showing the end shape of the die 14.

As shown in FIG. 2, the die 14 includes an upstream-side lip 23 and a downstream-side lip 25 in the running direction of the web 12. The extrusion opening 20A is formed between the lips.

The die 14 is formed into an overbite shape in which the downstream-side lip 25 protrudes to the web 12 more than the upstream-side lip 23. By using the die 14 of an overbite shape, the degree of decompression can be reduced in the suction chamber 22 and a bead can be formed suitably for thin film coating.

A distance L1 between the end of the downstream-side lip 25 and the end of the upstream-side lip 23 (hereinafter, referred to as an overbite amount) is preferably set at 30 μm to 100 μm and more preferably set at 30 μm to 80 μm. When the overbite amount L1 is smaller than this range, the effect of reducing the degree of decompression in the suction chamber 22 is weakened and results in an unstable bead. Contrarily when the overbite amount L1 exceeds the range, a bead becomes less stable.

Flat portions called lands are formed on the ends of the lips 23 and 25. Hereinafter, the flat portion on the upstream side in the running direction of the web 12 will be referred to as an upstream-side land 24 and the flat portion on the downstream side will be referred to as a downstream-side land 26.

The distance CL2 between the downstream-side land 26 and the web 12 wrapped around and supported on the backup roller 16 is set at 30 μm to 300 μm, preferably at 30 μm to 200 μm. The downstream-side land 26 has a length L2 in the running direction of the web 12 and the length L2 is set at 30 μm to 200 μm. When the length L2 of the downstream-side land 26 is smaller than this range, the edge or land 26 of the lip 25 is more likely to chip and stripes tend to appear on a coating. When the length L2 of the downstream-side land 26 exceeds the range, it becomes difficult to form a bead itself and thus a thin film coating also becomes hard to form.

The upstream-side land 24 has a length L3 in the running direction of the web 12 and the length L3 is set at 300 μm to 1500 μm.

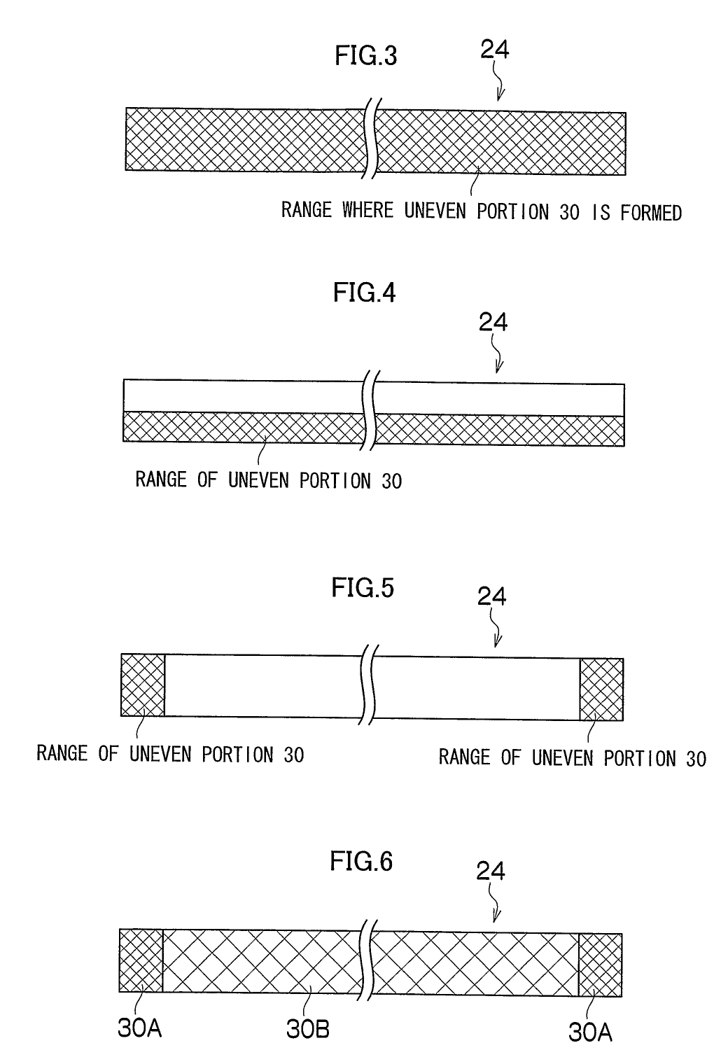

FIG. 3 is a front view showing the upstream-side land 24. As shown in FIG. 3, an uneven portion 30 is formed over the upstream-side land 24. The uneven portion 30 has a plurality of fine asperities which are shaped like, for example, diagonal lines, a lattice,, or pyramids of gravure engraving.

On the uneven portion 30, the asperities are 5 μm to 500 μm in depth (height), preferably 10 μm to 200 μm in depth (height). When the depth of the uneven portion 30 is smaller than this range, the effect of the provision of the uneven portion 30, that is, the effect of stabilizing a bead is weakened. Conversely when the depth of the uneven portion 30 exceeds the range, the straightness of the lip 23 is 5 μm or more, causing stripes or the like. Moreover, when the uneven portion 30 has a large depth, the manufacturing cost of the die 14 considerably increases.

On the uneven portion 30, the asperities are 50 μm to 500 μm in pitch, preferably 75 μm to 250 μm in pitch. When the pitch of the uneven portion 30 is smaller than this range, the straightness of the lip 23 decreases and thus a coating cannot be evenly formed. Conversely when the pitch of the uneven portion 30 exceeds this range, the effect of the uneven portion 30 cannot be sufficiently obtained and a bead becomes unstable. When the asperities have a small pitch on the uneven portion 30, it is preferable to reduce the depth of the asperities.

The following will describe the operation of the coating apparatus 10 configured thus.

When the coating solution is extruded from the slot 20 of the die 14, a bead is formed between the end of the die 14 and the web 12 on the backup roller 16. The bead has to be stably formed to prevent the occurrence of stripes. In order to stabilize the bead, it is important that a meniscus on the upstream side of the bead be pinned (fixed) on the upstream-side land 24. In this case, the bead is preferably pinned on the upstream side end of the upstream-side land 24.

In a conventional coating apparatus (in other words, in the case of a die where the upstream-side land 24 does not have the uneven portion 30), the material of the die 14 determines the stability of a bead. Therefore, a metallic die cannot stabilize a bead. Although a resin die can stabilize a bead more than a metallic die, problems of strength and processing accuracy arise. Also in the case of a resin die, a bead becomes unstable when a coating solution with a viscosity of 10 cp or less is applied with a wet coating amount of10 cc/m2 or less. Hence, in the conventional coating apparatus, a bead is more likely to be broken when affected by the disturbance of the entrained wind of the web 12 and a small foreign matter on the web 12, particularly when the speed of the web increases. Therefore, the conventional coating apparatus causes an uneven coating including stripes and disables continuous coating. Further, the conventional coating apparatus cannot increase the speed of the web 12 and reduces productivity.

In contrast to the conventional coating apparatus, in the present embodiment, the uneven portion 30 is formed on a surface of the upstream-side land 24. The uneven portion 30 makes it possible to increase a contact area between the coating solution and the upstream-side land 24, increase the gripping force of a bead, and stabilize the bead. Hence, when a pressure is reduced in the suction chamber 22 disposed under the bead, a meniscus on the upstream side of the bead can be stabilized and the meniscus of the bead can be positively pinned on the upstream-side land 24.

According to the present embodiment, since the uneven portion 30 is provided on the upstream-side land 24, a bead can be stabilized even when a coating solution with a viscosity of 10 cp or less is applied with a wet coating amount of 10 cc/m2. Particularly in the present embodiment, since the uneven portion 30 is provided over the upstream-side land 24, it is possible to considerably increase a contact area between the coating solution and the upstream-side land 24, thereby remarkably improving the stability of a bead. Therefore, the present embodiment enables high-speed coating in which the speed of the web 12 is increased to, for example, 20 m/min or more, thereby remarkably improving productivity.

The method of forming the uneven portion 30 is not limited to the gravure engraving described above. Any method is applicable as long as fine asperities are formed on the upstream-side land 24. Thus, for example, the metallic upstream-side land 24 may be matted with asperities. Moreover, a ceramic material and other metals may be sprayed to the upstream-side land 24 to form asperities on the upstream-side land 24. Further, ceramic or other metallic particles may be bonded to or embedded into the upstream-side land 24.

The depth and pitch on the uneven portion 30 do not always have to be uniform and the uneven portion 30 may be distributed within a 1-mm lip width. However, it is preferable that the distribution width is not different from an adjacent 1-mm width.

In the foregoing embodiment, the uneven portion 30 is formed over the upstream-side land 24. The configuration is not particularly limited to this and thus the uneven portion 30 may be formed on a part of the upstream-side land 24. For example, as shown in FIG. 4, the uneven portion 30 may be formed on the upstream-side half of the upstream-side land 24 (i.e., the lower half of FIG. 4). The uneven portion 30 formed thus makes it possible to linearly pin a meniscus on the upstream side of a bead in the width direction.

Further, as shown in FIG. 5, the uneven portions 30 may be provided only on both ends in the width direction of the upstream-side land 24. Since the bead is likely to be broken on both ends in the width direction, the bead can be stabilized by forming the uneven portions 30 only on both ends. Moreover, the center in the width direction is formed flat, thereby preventing a portion serving as a product from being adversely affected by the uneven portion 30 or forming an uneven thickness. The die of FIG. 5 thus makes it possible to form a coating film with a more even thickness. When the uneven portions 30 are formed on both ends as shown in FIG. 5, the uneven portion 30 is preferably disposed within a range corresponding to the ear of the web 12 (an edge portion not serving as a product).

As shown in FIG. 6, two kinds of uneven portions 30A and 30B may be formed on the upstream-side land 24. In this case, the uneven portions 30A on both ends in the width direction are formed with a larger depth or a smaller pitch than the uneven portion 30B disposed at the center in the width direction. Hence, a bead can be positively pinned on both ends where the bead is likely to be broken, and the bead can be positively pinned at the center serving as a product so as not to affect a change in thickness.

The coating solution of the present invention is preferably an organic solvent which includes, for example, particles of 10 nm to 10 μm used for forming an optical functional layer and includes an acrylic or epoxy resin and a fluorine containing monomer or polymer. The coating solution may be an aqueous solution where a solid matter is dispersed.

Further, a small wet coating amount is preferable in the present invention. This is because as the wet coating amount decreases, the effect of the present invention (in other words, the stabilization of a bead) is enhanced. Particularly when the wet coating amount is 10 cc/m2 or less, a bead is remarkably stabilized.

Moreover, a low viscosity is preferable for the coating solution in the present invention. This is because as the viscosity decreases, the effect of the present invention is enhanced. Particularly when the viscosity is 10 cp or less, a bead is remarkably stabilized. The effect of the present invention can be obtained even when the wet coating amount exceeds 10 cc/m2 or the viscosity exceeds 10 cp.

The effect of the present invention can be obtained also when the web (support) 12 used for the present invention is made of a material such as PET and TAC with a thickness of 40 μm to 200 μm and the web 12 is WP or other papers or other resin films.

### EXAMPLES

### Test 1

The die 14 had a slit clearance (CL1) of 200 μm, a lip clearance (CL2) of 100 μm, a land length (L2) of 50 μm on the downstream side, a land length (L3) of 1000 μm on the upstream side, a surface roughness of 0.3 S on the downstream-side land 26, an overbite amount (L1) of 100 μm, and a width of 1000 mm.

The backup roller 16 had a diameter of 200 mm and was coated with HCr plating with a surface roughness of 0.3 S. The suction chamber 22 had a degree of compression of 0.05 to 1.0 kPa. The web 12 was made of PET with a thickness of 100 μm and a width of 1100 mm. A coating solution was obtained by dissolving an acrylic resin in a MEK or cyclohexanone solvent and had a viscosity of 5 cp, a surface tension of 25 dyn/cm, and a coating amount of 7.5 cc/m2.

Under these conditions, tests were conducted for an example in which matting had been performed over the upstream-side land 24 of the die 14 with a depth of 5 μm to 50 μm to form the uneven portion 30 and a comparative example in which the upstream-side land 24 of the die 14 was made flat. The tests were conducted to find the upper limit coating speeds when the wet coating amount was fixed at 5 cc/m2 and a liquid viscosity was changed. A suction pressure is adjusted to find the upper limit coating speeds obtained when a bead was not broken. The results are shown in Table 1.

TABLE 1

| | Upper Limit Coating Speed (m/min) | | | |
|---|---|---|---|---|
| | Viscosity | Viscosity | | |
| | 20 cp | 12 cp | Viscosity 10 cp | Viscosity 5 cp |
| Example 1 | 100 m/min | 70 m/min | 60 m/min | 50 m/min |
| Comparative | 80 m/min | 35 m/min | 25 m/min | 15 m/min |
| Example 1 | | | | |

As is understood from Table 1, regardless of the viscosity, the example having the uneven portion 30 could always obtain upper limit coating speeds higher than those of the comparative example not having the uneven portion 30. Further, it was found that as the coating solution increases in viscosity, a difference in the upper limit coating speed (that is, the effect of the present invention) between the example and the comparative example increases. Moreover, the results indicate that a difference in the upper limit coating speed increases particularly when the coating viscosity is 10 cp or less.

### Test 2

Contrary to Test 1, tests were conducted while a liquid viscosity was fixed at 5 cp and a wet coating amount was changed. Test results are shown in Table 2.

TABLE 2

| Upper Limit Coating Speed (m/min) | | | |
|---|---|---|---|
| Coating Amount | Coating Amount | Coating Amount | Coating Amount |
| 20 cc/m² | 12 cc/m² | 10 cc/m² | 5 cc/m² |

| | | | | |
|---|---|---|---|---|
| Example 2 | 120 m/min | 70 m/min | 60 m/min | 50 m/min |
| Comparative | 100 m/min | 50 m/min | 35 m/min | 15 m/min |
| Example 2 | | | | |

As is understood from Table 2, regardless of the wet coating amount, the example having the uneven portion 30 could always obtain upper limit coating speeds higher than those of the comparative example not having the uneven portion 30. Further, it was found that as the wet coating amount decreases, a difference in the upper limit speed (that is, the effect of the present invention) between the example and the comparative example increases. Moreover, the results indicate that a difference in the upper limit coating speed increases particularly when the wet coating amount is 10 cc/m2 or less.

### Test 3

In Example 3, a die 24 was used in which uneven portions 30 were formed on both ends of 10 mm in the width direction of an upstream-side land 24. The uneven portion 30 had asperities with a fixed pitch of 50 μm and tests were conducted with a varying depth. The wet coating amount was fixed at 5 cc/m2 and the liquid viscosity was fixed at 5 cp. Tests were conducted for a comparative example having no asperities. Test results are shown in Table 3.

TABLE 3

| | Upper Limit Coating Speed (m/min) | | | | |
|---|---|---|---|---|---|
| | Depth | Depth | Depth | Depth | Depth |
| | 3 μm | 5 μm | 50 μm | 500 μm | 550 μm |
| Example 3 | 17 m/min | 25 m/min | 50 m/min | 70 m/min | 80 m/min (*) |

| | |
|---|---|
| Compar- | 15 m/min |
| ative | |
| Example 3 | |

(*) Uneven coating was found

As is understood from Table 3, in the example having the uneven portion 30, the deeper the asperities, the upper limit coating speed becomes higher. Further, it was found that the effect of increasing the upper limit coating speed is hardly obtained when the depth of the asperities falls below 5 μm. The results indicate that when the uneven portion 30 has a depth larger than 500 μm, the upper limit coating speed can be increased, though an uneven coating including stripes occurs.

### Test 4

Contrary to Test 3, the depth of asperities was fixed at 50 μm, and tests were conducted while changing the pitch of the asperities. A comparative example shows test results obtained by a die having no asperities. The test results are shown in Table 4.

TABLE 4

| | Upper Limit Coating Speed (m/min) | | | | |
|---|---|---|---|---|---|
| | Pitch | Pitch | Pitch | Pitch | Pitch |
| | 30 μm | 50 μm | 100 μm | 500 μm | 550 μm |
| Example 4 | 55 m/min | 60 m/min | 50 m/min | 20 m/min | 18 m/min |

| | |
|---|---|
| Compar- | 15 m/min |
| ative | |
| Example 4 | |

As is understood from Table 4, in the example having the uneven portion 30, the smaller pitch of the asperities, the upper limit coating speed could increase. A pitch less than 50 μm contrarily reduces the upper limit coating speed. Moreover, it was found that a pitch exceeding 500 μm weakens the effect of increasing the upper limit speed.

1-8. (canceled)

9. A coating method, in which coating is performed with a wet coating amount of 10 cc/m2 or less by extruding a coating solution with a viscosity of 10 cp or less from a extrusion opening of a die to a continuously running web supported by a backup roller,
characterized in that the coating is performed by means of the die in which a lip on a downstream side of the extrusion opening is protruded to the web more than a lip on an upstream side of the extrusion opening relative to a running direction of the web, and an uneven portion including a plurality of asperities is formed on a land on an end of the upstream-side lip.

10. The coating method according to claim 9, characterized in that the uneven portion is formed over the land of the upstream side.

11. The coating method according to claim 9, characterized in that the uneven portion is formed on both ends in a width direction of the land of the upstream side.

12. The coating method according to claim 9, characterized in that the asperities of the uneven portion have a depth of 5 μm to 500 μm and a pitch of 50 μm to 500 μm.

13. The coating method according to claim 10, characterized in that the asperities of the uneven portion have a depth of 5 μm to 500 μm and a pitch of 50 μm to 500 μm.

14. The coating method according to claim 11, characterized in that the asperities of the uneven portion have a depth of 5 μm to 500 μm and a pitch of 50 μm to 500 μm.

15. The coating method according to claim 9, characterized in that the uneven portion is formed by performing matting, ceramic spraying, or engraving on the land of the upstream side.

16. The coating method according to claim 10, characterized in that the uneven portion is formed by performing matting, ceramic spraying, or engraving on the land of the upstream side.

17. The coating method according to claim 11, characterized in that the uneven portion is formed by performing matting, ceramic spraying, or engraving on the land of the upstream side.

18. The coating method according to claim 12, characterized in that the uneven portion is formed by performing matting, ceramic spraying, or engraving on the land of the upstream side.

19. The coating method according to claim 13, characterized in that the uneven portion is formed by performing matting, ceramic spraying, or engraving on the land of the upstream side.

20. The coating method according to claim 14, characterized in that the uneven portion is formed by performing matting, ceramic spraying, or engraving on the land of the upstream side.

21. The coating method according to claim 9, characterized in that the coating solution is an organic solvent containing particles of 10 nm to 10 μm.

22. The coating method according to claim 10, characterized in that the coating solution is an organic solvent containing particles of 10 nm to 10 μm.

23. The coating method according to claim 11, characterized in that the coating solution is an organic solvent containing particles of 10 nm to 10 μm.

24. The coating method according to claim 12, characterized in that the coating solution is an organic solvent containing particles of 10 nm to 10 μm.

25. The coating method according to claim 15, characterized in that the coating solution is an organic solvent containing particles of 10 nm to 10 μm.

26. The coating method according to claim 18, characterized in that the coating solution is an organic solvent containing particles of 10 nm to 10 μm.

27. The coating method according to claim 21, characterized in that the coating solution contains an acrylic UV curing resin or an epoxy thermosetting resin.

28. The coating method according to claim 22, characterized in that the coating solution contains an acrylic UV curing resin or an epoxy thermosetting resin.

29. The coating method according to claim 23, characterized in that the coating solution contains an acrylic UV curing resin or an epoxy thermosetting resin.

30. The coating method according to claim 26, characterized in that the coating 10 solution contains an acrylic UV curing resin or an epoxy thermosetting resin.

31. A coating apparatus including a backup roller for supporting a continuously running web, and a die having an extrusion opening for a coating solution, the die being disposed close to the web wrapped around the backup roller, the apparatus coating the web with the coating solution having a viscosity of 10 cp or less with a wet coating amount of 10 cc/m2 or less,
characterized in that in the die, a lip on a downstream side of the extrusion opening is protruded to the web more than a lip on an upstream side of the extrusion opening relative to a running direction of the web, and an uneven portion including a plurality of asperities is formed on a land on an end of the upstream-side lip.
